(19) United States
(12) Patent Application Publication
(10) Pub. No.: US 2006/0275732 A1
(43) Pub. Date: Dec. 7, 2006

(54) Curing light

(75) Inventor: Densen Cao, Sandy, UT (US)

Correspondence Address: Parsons Behle & Latimer;Suite 1800, 201 South Main Street, P.O. Box 45898, Salt Lake City, UT, 84111, US

(73) Assignee: Cao Group, Inc.

(21) Appl. No.: 11/444,280

(22) Filed: May 31, 2006

Related U.S. Application Data
(60) Provisional application No. 60/686,281, filed on Jun. 1, 2005.

(51) Int. Cl. A61C 1/00

(52) U.S. Cl. 433/29

(57) ABSTRACT

Curing lights can be constructed using more than one LED, where at least 2 of the LEDs have different spectral profiles in order to have the capability to activate initiators sensitive to light of different wavelengths. A heat sink handle may be used to heat management.

### PRIORITY

This patent application claims benefit of and priority to U.S. Provisional Patent Application Ser. No. 60/686,281 filed on Jun. 1, 2005, which is hereby incorporated by reference.

### BACKGROUND

In the field of dentistry, and in other fields where monomers are polymerized using a light-sensitive initiator (i.e., cured), there is a need for a curing light that produces light across a wide spectrum of light wavelengths in order to cure various materials which use initiators sensitive to different light wavelengths.

### SUMMARY

Curing lights can be constructed using more than one LED, where at least 2 of the LEDs have different spectral profiles in order to have the capability to activate initiators sensitive to light of different wavelengths.

### BRIEF DESCRIPTION OF DRAWINGS

FIG. 1 depicts a cordless LED curing light and a charging unit.

FIG. 2a depicts a cross sectional view of the curing light.

FIG. 2b depicts another cross sectional view of the curing light.

FIG. 3a depicts a distal view of the light source.

FIG. 3b depicts a side view of the light source.

FIG. 4 depicts a light module for the curing light.

FIG. 5 depicts a control panel for the curing light.

### DETAILED DESCRIPTION

Devices disclosed include corded or cordless curing lights for curing light-curable composites and adhesives. A curing light can use two LEDs as light sources to provide e a wide output spectra to cure many different composites with different initiators. As an example, a first LED may output light at about 400 nm, while a second LED outputs light at about 470 nm. This provides a broader spectral output than using two LEDs of the same wavelength. The housing of the curing light can be used as a heat sink to managing the heat generated by the LEDs. The light has a unique display on the handle to communicate information to a user.

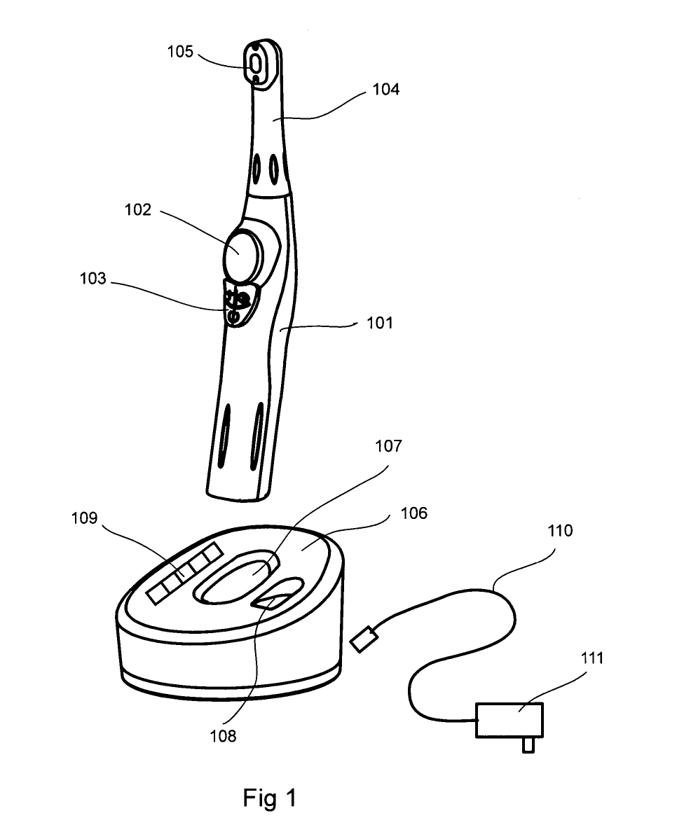

FIG. 1 depicts curing light and its charger. A handle 101 is provided on which a display 102 is mounted for communicating information to a user.

Control pad 103 permits a user to control operation of the curing light. Control pad 103 can be used to control things such as power level, mode of operation (pulsed, continuous wave, etc.) and timer. A detachable wand 104 may be provided. If desired, the wand 104 can be detachable from the handle 101. The wand 104 includes a light module 105 from which light exits the curing light. A charger or charging base 106 is provided with a receptacle 107 for accepting the handle 101 therein. The handle 101 has one or more batteries within it which are charged by the charging base. A light meter 108 can be provided on the base for measuring light intensity output from the curing light. A display 109 indicating light intensity or charging status can be included. A cord 110 and power supply 111 operate with an AC outlet to charge the light.

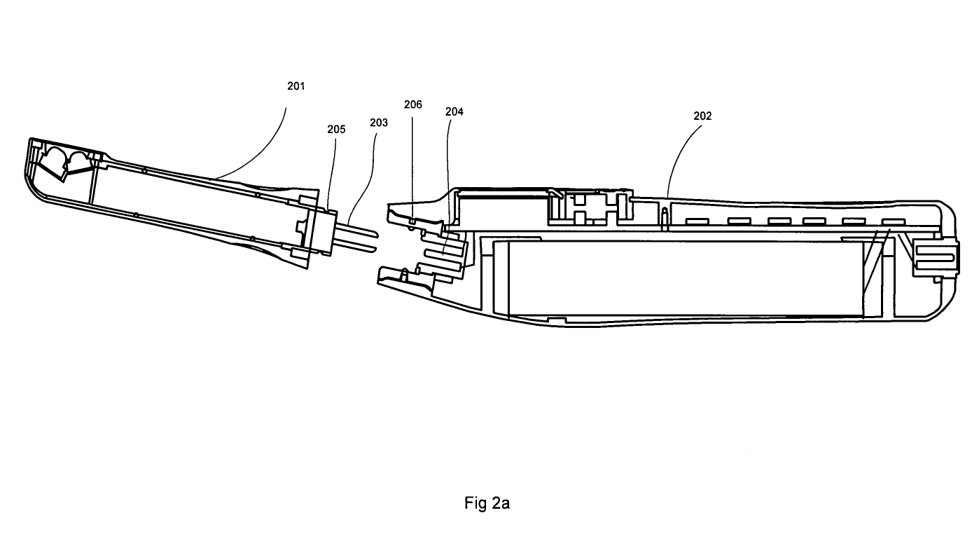

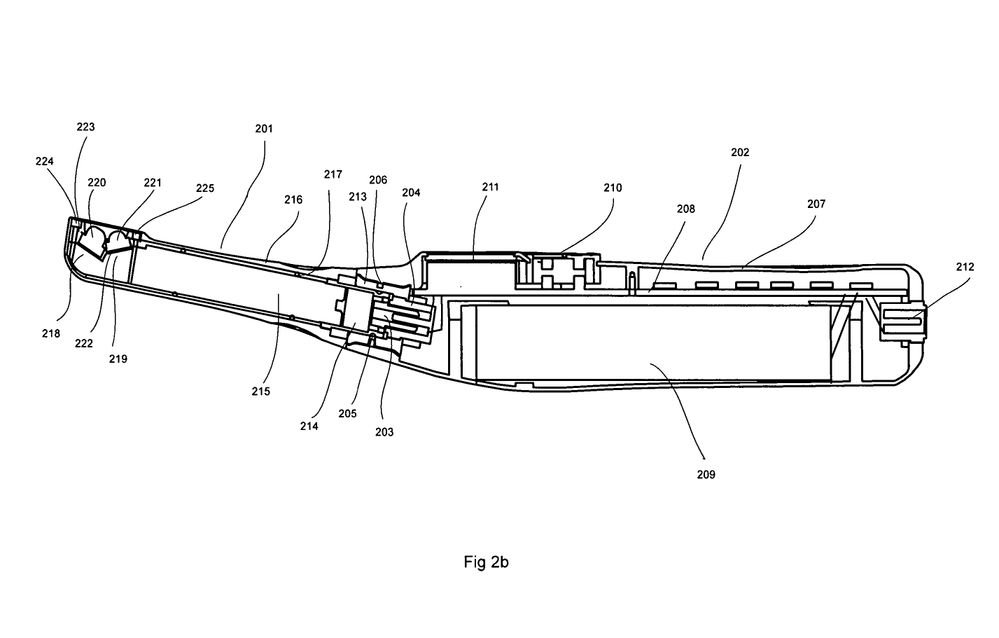

FIG. 2a depicts a cross-sectional view of the curing light of FIG. 1 with the wand or light source detached from the body or handle. The curing light has two main parts, wand 201, and main body or handle 202. The wand is attached to the body through a matched quick connector 203 in wand side and 204 in body side. The wand 201 is held in the body by friction fit through a spring mechanism 205 and 206 on wand and body sides respectively. Heat can be transferred through the quick coupler from the wand to the handle of the curing light in order to move heat away from the LEDs and to avoid heat buildup which shortens the life of LEDs and which can be dangerous to a patient in a dental application.

FIG. 2b depicts another cross-sectional view of the curing light. In the body 202, there is a housing 207 which is being made of metal materials. The interior 207 of the body includes a control circuit 208 which controls the electrical and optical properties of the curing light. A rechargeable battery 209 is included. Control pad 210 and display screen 211 are also provided. An input 212 for charging the battery is located at the end of main body 202. A quick connect 204 is embedded in the main body 202. A metal ring 213 is attached to metal housing 207. A matching metal ring 214 is on the wand side 201 for friction fit between the wand and handle. The ring 214 can be a separate part or integral with the heatsink 215 which is inside housing 216. There is an insulation layer 217 between wand housing 216 and heatsink 215. On the heatsink 215, there are two mounting platforms 218 and 219 for LED mounting. Two LEDs 220 and 221 are placed on top of the two mounting platforms with heat conductive paste 222 between LEDs and the heatsink to facilitate heat transfer. LEDs 220 and 221 are attached to the heatsink through a reflector 223 and screws 224 and 225.

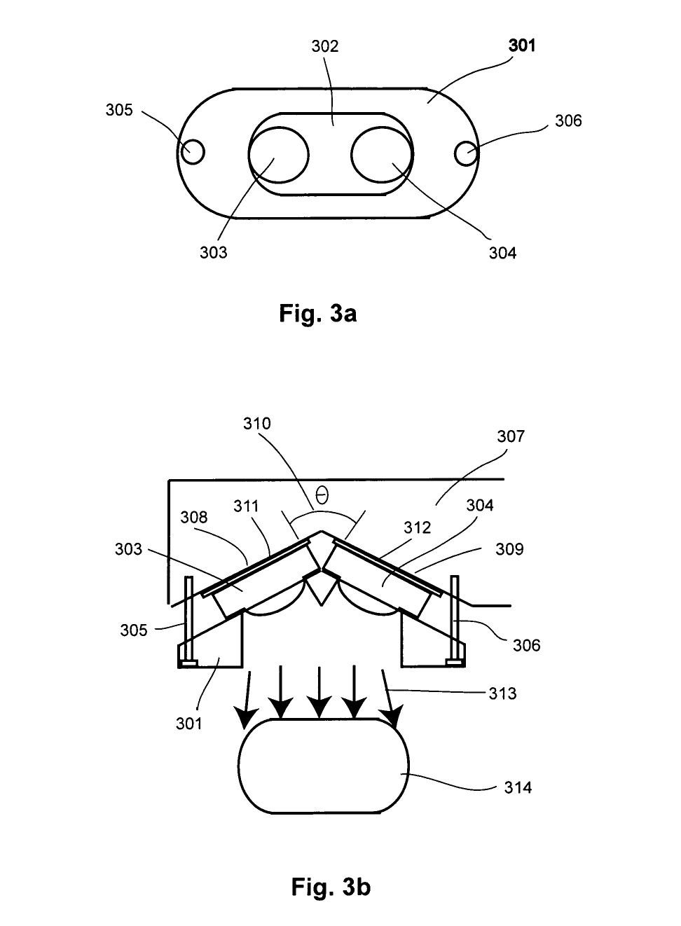

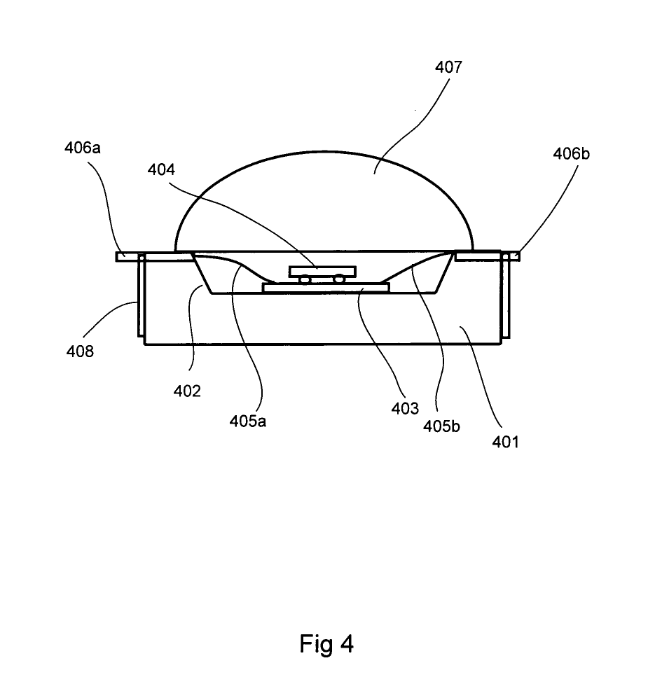

FIG. 3a depicts a top view of a light exit on the wand. A reflector 301 with a reflection cone 302 are used to gather and reflect light from two LEDs 303 and 304 which are inside the reflection cone 302. Two screws 305 and 306 are used to attache reflector and LEDs to the heatsink.

FIG. 3b depicts a cross-sectional view of the light exit section of the curing light. The heat sink 207 has two mounting platforms or facets 308 and 309. The two facets 308 and 309 are arranged at an angel 310 to position the two LEDs 303 and 304 such a way to stratify the light beam requirement. The LEDs are attached to heatsink using reflector 301 and screws 305 and 306. Heat conduction paste between the LEDs and the heat sink facet. In this construct, if the LEDs are not working for any reason, they can be changed by removing screws from the heat sink. The light beam 313 exits to create a footprint 314. The shape of the footprint 314 can be oval, circular or any shape desired. The combination of LED emitting pattern, arrangement angle of metal facets and the shape of the light reflector cone determines the shape and profile of the light beam. The wavelength of each LED can range from 280 to 5000 nm or otherwise.

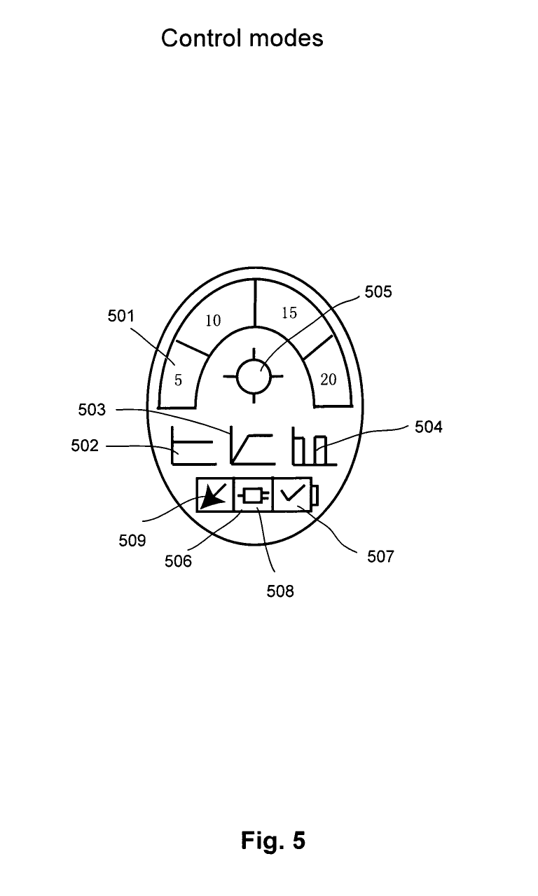

FIG. 4 depicts a side view of an LED module. Generally there is a heat sink 401 with a reflective wall of a well 402. Sometimes, there is no need for reflector 402. A chip carrier 403 with a chip 404 placed on top is attached to heatsink 401. Sometimes, the chip can be directly attached to heatsink 401 without carrier 403. The chip electrodes are connected through wire 405a and 406b to electrodes 406a and 406b in the housing. A optical lens or other optical means 407 is placed on top of heatsink 401 to get a desired optical beam from the chip. There is a housing 208 outside of the heat sink for protection purposes. Sometimes, the housing may not be needed when different heatsink materials is used.

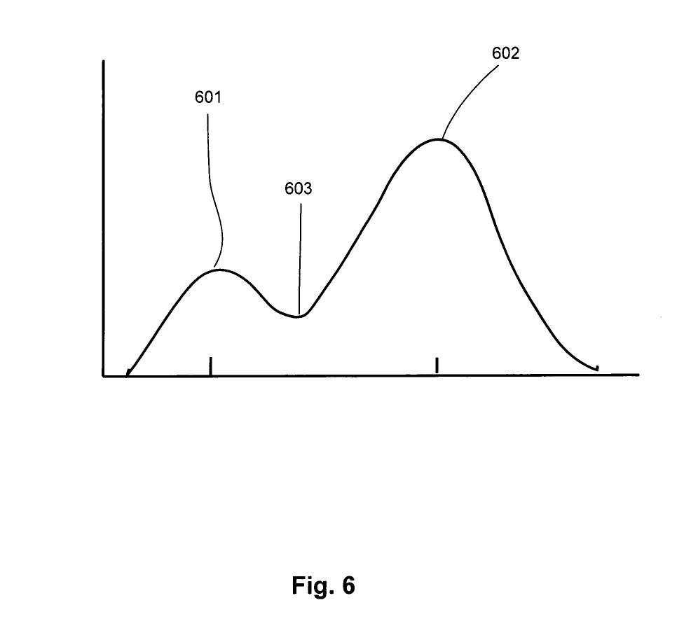

FIG. 5 depicts an example display for the curing light. The display can be made of LEDs, LCD and other means. On the display, there is a timer indicator 501 to illustrate the time setting. There are 4 indicators for curing mode. An indicator 502 indicates constant output power curing mode. Another indicator 503 indicates ramping output power curing mode. Another indicator 504 indicates pulse curing mode. Indicator 505 indicates boost power curing mode. There is a battery status indicator 506 which informs the user of the status of the curing light battery. There are three status indicators for the battery. Indicator 507 indicates the battery is full. Indicator 508 indicates the battery is being charged. Indicator 509 indicates that the battery is low and needs to be charged.

FIG. 6 depicts an example the light spectrum output profile when the curing light uses 2 LEDs of different peak wavelengths in order to provide a broad spectrum curing light. As shown, there are two peaks in the light profile. A first peak 601 is located between 350 and 430 nm. A second peak 602 is located in the 440 to 490 nm range. There is a valley between two peaks. Depending on the combination of LEDs, the output spectra can have one peak located between 350 and 430 nm and another between 430 and 490 nm. A two peak profile is useful in curing a variety of composites with different initiators.

While the present invention has been described and illustrated in conjunction with a number of specific embodiments, those skilled in the art will appreciate that variations and modifications may be made without departing from the principles of the invention as herein illustrated, described, and claimed. The present invention may be embodied in other specific forms without departing from its spirit or essential characteristics. The described embodiments are to be considered in all respects as only illustrative, and not restrictive. All changes which come within the meaning and range of equivalency of the claims are to be embraced within their scope.

1. A curing light comprising:
a main body,
said main body having a housing made of a heat sink material,
control circuitry within said main body for controlling operation of the curing light,
a control panel for controlling operation of the curing light through said control circuitry,
a display on said main body for displaying status and operation of the curing light,
a battery in said main body for powering the curing light,
a main body detachable quick coupler located on said main body distal end,
said detachable quick coupler being in a heat-conductive relationship with said housing, a wand,
said wand having a wand detachable quick coupler for rapidly coupling to and decoupling from said main body detachable quick coupler,
said wand having a heat sink within it,
said heat sink being in heat conductance with said wand detachable quick coupler in order to transmit heat from said wand to said housing,
at least two mounting platforms on said heat sink distal end for mounting an LED thereon,
said mounting platforms having LEDs mounted on them,
said mounting platforms being configured at an angular orientation with respect to each other to create a desired light beam.

2. A device as recited in claim 1 further comprising heat paste between said LEDs and said mounting platforms in order to facilitate conductance of heat from said LEDs to said heat sink.

3. A device as recited in claim 1 further comprising a plurality of screws for mechanically affixing said LEDs to said mounting platforms.

4. A device as recited in claim 1 wherein said wand has a casing, and an insulator between said casing and said heat sink.

5. A device as recited in claim 1 wherein said quick detachable couplers are made at least in part from metal.

6. A device as recited in claim 1 wherein said quick detachable couplers achieve a friction fit between said wand and said handle.

7. A device as recited in claim 1 further comprising a charging base.

8. A device as recited in claim 1 further comprising a light reflector for reflecting light emitted by said LEDs in a useful direction.

9. A device as recited in claim 1 wherein a first LED has a light spectral output centered around a first wavelength, and wherein a second LED has a light spectral output centered around a second wavelength, and wherein said first and second wavelengths are different.

10. A device as recited in claim 9 wherein the curing light produces a wide spectral output to cure composite materials with different initiators.

11. A device as recited in claim 1 wherein each of said LEDs emits light of a wavelength between 280 nm to 5000 nm, and wherein each of said LEDs emits light at a wavelength peak measurably different from each of said other LEDs.

12. A device as recited in claim 12 claim 11 wherein the curing light emits light having a spectral profile with two peaks and a valley in between.

13. A curing light comprising:
a main body,
said main body having a housing made at least in part of a heat sink material,
a main body detachable quick coupler located on said main body distal end, said detachable quick coupler being in a heat-conductive relationship with said housing,
a wand,
said wand having a wand detachable quick coupler for rapidly coupling to and decoupling from said main body detachable quick coupler,
said wand having a heat sink within it,
said heat sink being in heat conductance with said wand detachable quick coupler in order to transmit heat from said wand to said housing,
at least two mounting platforms on said heat sink distal end for mounting an LED thereon,
said mounting platforms having LEDs mounted on them,
said mounting platforms being configured at an angular orientation with respect to each other to create a desired light beam;
the curing light having a heat path beginning at said LEDs where heat is produced, thence to said wand heat sink which communicates heat to said wand quick coupler, said wand quick coupler transferring heat to said housing quick coupler, and said housing quick coupler transferring heat to said housing where it dissipates.
